(19) United States
(12) Patent Application Publication
(10) Pub. No.: US 2026/0237574 A1
(43) Pub. Date: Aug. 13, 2026

(54) COUNTERTOP SWITCH FOR GARBAGE DISPOSAL

(71) Applicant: Karran USA, LLC, Vincennes, IN (US)

(72) Inventor: Todd Alexander, Vincennes, IN (US)

(21) Appl. No.: 19/572,221

(22) Filed: Mar. 19, 2026

Related U.S. Application Data
(63) Continuation-in-part of application No. 19/536,849, filed on Feb. 11, 2026.
(60) Provisional application No. 63/757,050, filed on Feb. 11, 2025.

(51) Int. Cl. H01H 13/14; E03C 1/266; H01R 31/06

(52) U.S. Cl. CPC H01H 13/14; E03C 1/2665; H01R 31/06

(57) ABSTRACT

A power control device is configured for use with a garbage disposal positioned below a kitchen sink mounted in a countertop. The power control device comprises a switch, an electrical lead, and a power adapter. The switch is configured for mounting on the countertop. The electrical lead includes a proximal end and a distal end. The proximal end is connected to the switch and the distal end is connected to the power adapter. The power adapter includes prongs and at least one receptacle. The prongs are configured for insertion into a power outlet. The at least one receptacle is configured to receive a power plug of the garbage disposal. A user may selectively toggle the switch between an on and off position in order to control the delivery of electrical power to the garbage disposal.

### CROSS-REFERENCE TO RELATED APPLICATIONS

The present application is a continuation-in-part of U.S. patent application Ser. No. 19/536,849, filed Feb. 11, 2026, which claims priority to U.S. Provisional Patent Application No. 63/757,050, filed Feb. 11, 2025, the entire contents of which are incorporated by reference herein.

### FIELD

The present disclosure relates to kitchen appliances and particularly to kitchen garbage disposals.

### BACKGROUND

Garbage disposals are known in the kitchen and plumbing industry. Garbage disposals are electrically powered devices that are installed under a kitchen sink between the sink's drain and the trap. The garbage disposal receives waste matter from the sink, including fluid waste (e.g., water flowing out of the sink) and solid waste (e.g., food waste), and shreds solid waste into pieces small enough to pass through plumbing.

As illustrated in FIG. 10, a typical prior art garbage disposal 100 includes a cylindrical housing 110, a sink attachment 120, an upper chamber 140, a lower chamber 160, a grinder 150 positioned between the upper chamber 140 and the lower chamber 160, an electric motor 170, and a waste outlet/line 180. The garbage disposal receives waste matter/debris from a kitchen sink via the sink attachment 120. After passing through the sink attachment 120, the waste is received in the upper chamber 140 and delivered to the grinder 150. At the grinder 150, food and other solid waste is forced by rotating impellers against a stationary, circular grind ring, pulverizing the solid waste into fine particles. Fluid flowing through the disposal then washes the fine particles into the lower chamber 160, into the waste outlet 180, and down the drain.

The garbage disposal is typically controlled by a toggle switch on a kitchen backsplash. In at least some embodiments, the garbage disposal is hardwired to the switch by electric wiring within the residence or commercial establishment. In other embodiments, the garbage disposal includes a power cord and a power plug configured to be plugged into an electrical outlet controlled by the toggle switch. In the “on” position, the toggle switch delivers electrical power to the garbage disposal. In the “off” position, the toggle switch deprives the garbage disposal of electrical power. However, the position of the toggle switch on the backsplash is often inconvenient for users who must reach all the way to the backstop in order to control the garbage disposal. Additionally, a toggle switch on a kitchen backsplash may be unsightly and interfere with the overall theme of the backsplash. Furthermore, a standard toggle switch does not provide any aesthetic design features for the homeowner or other user of the kitchen.

In view of the foregoing, it would be advantageous to provide a garbage disposal control device that is conveniently located within a kitchen and easily accessible by the user. It would be of further advantage if such a control device included aesthetically pleasing design features for a kitchen. It would also be advantageous if the control device was inexpensive and easy to install with new garbage disposal installations or easily retro-fit to existing garbage disposal installations.

### SUMMARY

A power control device for a garbage disposal is disclosed herein. The power control device is configured for use with a garbage disposal that is positioned below a kitchen sink mounted in a countertop. The power control device comprises a switch, an electrical lead, and a power adapter. The switch is configured for mounting on the countertop. The electrical lead includes a proximal end and a distal end. The proximal end is connected to the switch and the distal end is connected to the power adapter. The power adapter includes prongs and at least one receptacle. The prongs are configured for insertion into a power outlet and the at least one receptacle is configured to receive a power plug of the garbage disposal.

In at least one embodiment, a method of operating a garbage disposal is disclosed. The method includes moving an upper switch positioned above the garbage disposal to an ON state. Thereafter, the method includes providing electric power to an electric motor of the garbage disposal when the upper switch is in the ON state, and providing electric power to a light fixture on the garbage disposal when the upper switch is in the ON state.

In another embodiment, a method is disclosed for operating a garbage disposal under a kitchen sink mounted in a kitchen countertop. The method includes mounting a switch of a power control device for the garbage disposal in a hole in the countertop. The method also includes providing an electrical connection between the switch and a power adapter of the power control device. The method further includes plugging prongs of the power adapter into a power outlet under the countertop. Thereafter, the method includes plugging a power plug of the garbage disposal into a receptacle on the power adapter. Then, the method includes selectively operating the switch to cause the adapter to provide electrical power to the garbage disposal or deprive the garbage disposal of electrical power.

In at least one additional embodiment disclosed herein, a kitchen sink installation includes a power control device for a garbage disposal. The kitchen sink installation includes a countertop with a kitchen sink installed in the countertop and a garbage disposal installed under the kitchen sink. The garbage disposal includes a power cord and a power plug. The power control device for the garbage disposal includes a switch and a power adapter. The switch is mounted on the countertop. The power adapter is electrically connected to the switch. The power adapter includes prongs and at least one receptacle. The prongs of the power adapter engage an electrical power outlet. The power plug of the garbage disposal is plugged into the at least one receptacle of the power adapter.

The above-described features and advantages, as well as others, will become more readily apparent to those of ordinary skill in the art by reference to the following detailed description and accompanying drawings. While it would be desirable to provide a garbage disposal that provides one or more of these or other advantageous features as may be apparent to those reviewing this disclosure, the teachings disclosed herein extend to those embodiments which fall within the scope of any eventually appended claims, regardless of whether they include or accomplish one or more of the advantages or features mentioned herein.

### BRIEF DESCRIPTION OF THE DRAWINGS

FIG. 1 shows a front perspective view of a garbage disposal with a light fixture;

FIG. 2 shows a side elevational view of the garbage disposal of FIG. 1;

FIG. 3 shows a rear elevational view of the garbage disposal of FIG. 1;

FIG. 4 shows the garbage disposal of FIG. 1 installed in an under-counter compartment of kitchen cabinetry;

FIG. 5 shows a power switch for the garbage disposal of FIG. 1 installed on a countertop, the power switch including an LED ring;

FIG. 6 is a table showing the status of the light fixture of the garbage disposal of FIG. 1 when a first switch and a second switch are in different states;

FIG. 7 is a flowchart illustrating operation of the light fixture of the garbage disposal of FIG. 1 depending on the states of the first switch or the second switch;

FIG. 8 is a flowchart illustrating a method of determining a fault condition in the garbage disposal of FIG. 1;

FIG. 9 is a perspective view of an alternative embodiment of the power switch of FIG. 5; and

FIG. 10 is a cutaway view of a prior art garbage disposal.

### DESCRIPTION

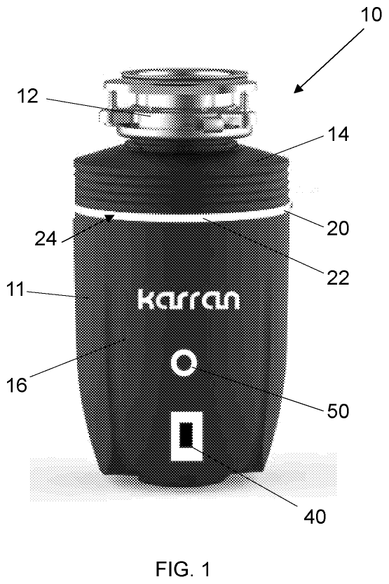

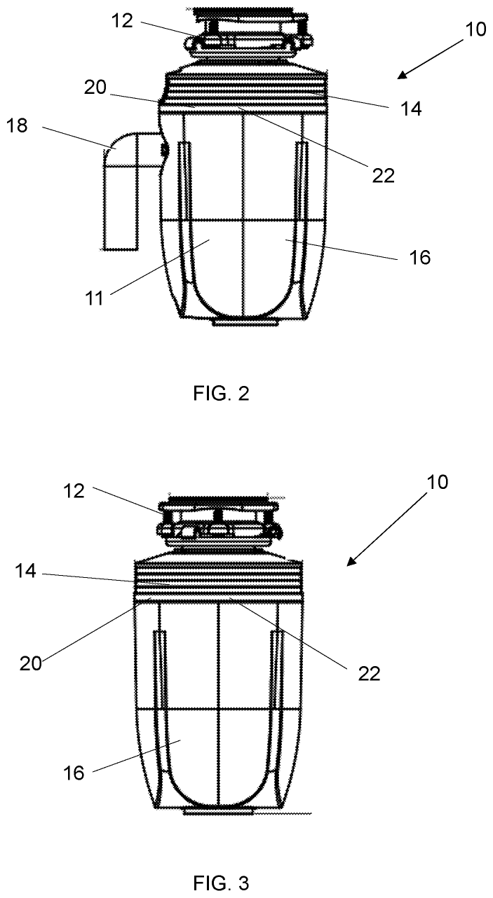

With reference now to FIGS. 1-4, a garbage disposal 10 includes a housing 11, a sink attachment 12, an upper chamber 14 and a lower chamber 16 positioned within the housing 11, a waste line 18, and at least one light fixture 20. As explained in further detail herein, the light fixture 20 may be provided as a ring of LEDs that illuminate upon the occurrence of certain events, such as the flip of a switch or the occurrence of an event, such as movement in the vicinity of the garbage disposal 10 or the opening of a cabinet door.

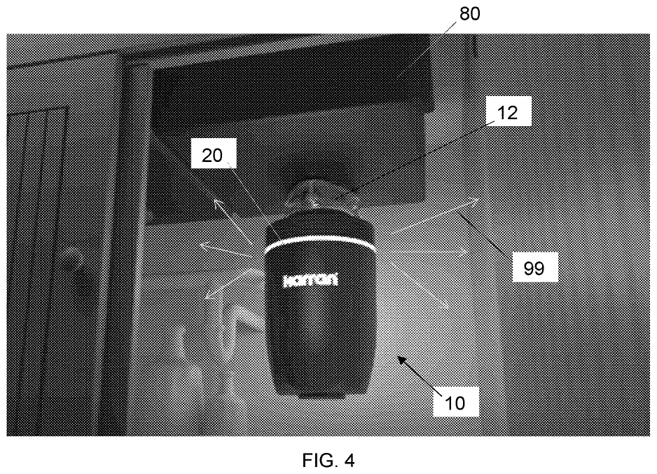

The sink attachment 12 is a conventional sink attachment that couples the garbage disposal 10 to a drain of a sink 80 (see FIG. 4). The sink attachment 12 specifically provides a coupling between the sink and the housing 11 of the garbage disposal 10. Liquid and debris flowing down the drain passes through the sink attachment 12 and into the upper chamber 14 of the garbage disposal.

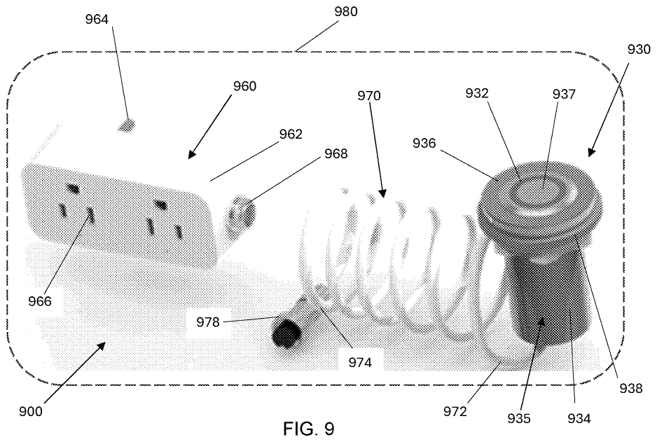

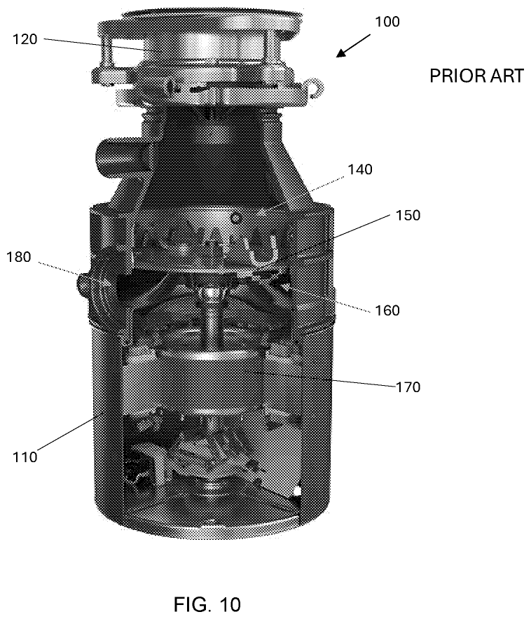

The housing 11 is substantially cylindrical in shape with a cylindrical outer wall that provides a canister structure for the garbage disposal 10. The upper chamber 14 of the garbage disposal 10 is positioned within the housing 11 and defines a cavity that receives a volume of liquid and debris from the sink. A grinder with a shredder ring (e.g., see grinder 150 of FIG. 9) is positioned between the upper chamber 14 and the lower chamber 16. When driven by an electric motor, the shredder ring acts to shred food waste into pieces that are small enough to pass through plumbing attached to the lower chamber 16.

The lower chamber 16 is also positioned within the housing 11 and receives liquid and solid waste matter that passes from the upper chamber 14 and through the grinder. An insulated electric motor (e.g., see motor 170 of FIG. 9) is positioned in the lower chamber 16. A drive axis connects the insulated motor to the shredder ring. When electric power is provided to the electric motor, the motor rotates the shredder ring and shreds the food waste in the upper chamber 14, thus allowing it to pass to the lower chamber 16.

The waste line 18 is connected to an outlet in the lower chamber. Liquid and shredded food waste pass through the outlet and into the waste line. The waste line 18 leads to other plumbing that purges the liquid and waste from the facility where the garbage disposal is located (e.g., the plumbing directs solid and liquid waste matter out of a residence and to an ejector pit and/or a sewer or septic system).

### Light Fixture on Garbage Disposal

As best shown in FIGS. 1 and 4, the light fixture 20 is provided as a ring of light-emitting diodes (LEDs) 22 that is positioned between the upper chamber 14 and the lower chamber 16 of the garbage disposal 10. In the disclosed embodiment, the LED ring 22 encircles the entire housing 11 of the garbage disposal, including the front and sides and emits light outwardly from the cylindrical wall of the housing (as illustrated by arrows 99 in FIG. 4). In other embodiments, the LED ring 22 may be a partial disc structure that only encircles a portion of the housing. In at least some embodiments, the LED ring 22 may be provided by an LED strip that is covered by a diffuser 24. The diffuser 24 at least partially shields the LEDs and prevents the LEDs from shining light directly into the eyes of an onlooker.

While the light fixture 20 is shown in FIG. 1 as an LED ring 22, it will be recognized that the light fixture may be provided in other forms in other embodiments, such as differently positioned LEDs and/or incandescent lights on other locations of the garbage disposal 10. For example, in at least one embodiment, the light fixture 20 may be positioned on a base of the garbage disposal 10 (e.g., under the lower chamber 16 at a bottom of the housing 11) such that it shines light downwardly from the base (i.e., away from the eyes of an onlooker). Such light fixture may be in lieu of or in addition to the LED ring 22. In other embodiments, the light fixture 20 may be positioned on the rear of the garbage disposal and only shine light in the rearward direction (again, away from the eyes of an onlooker).

The LED ring 22 may include any number of LEDs which may be identical LEDs or different types of LEDs. For example, the LEDs may emit different colors of light, or all the same color of light. In at least one embodiment, the LEDs all emit a steady, relatively warm white light in the range of 2700 to 4500 Kelvin. In at least some embodiments, the LEDs may change color temperatures and color over time, thus producing a light-show effect from the LEDS.

### Power Switch for Garbage Disposal and/or Light Fixture

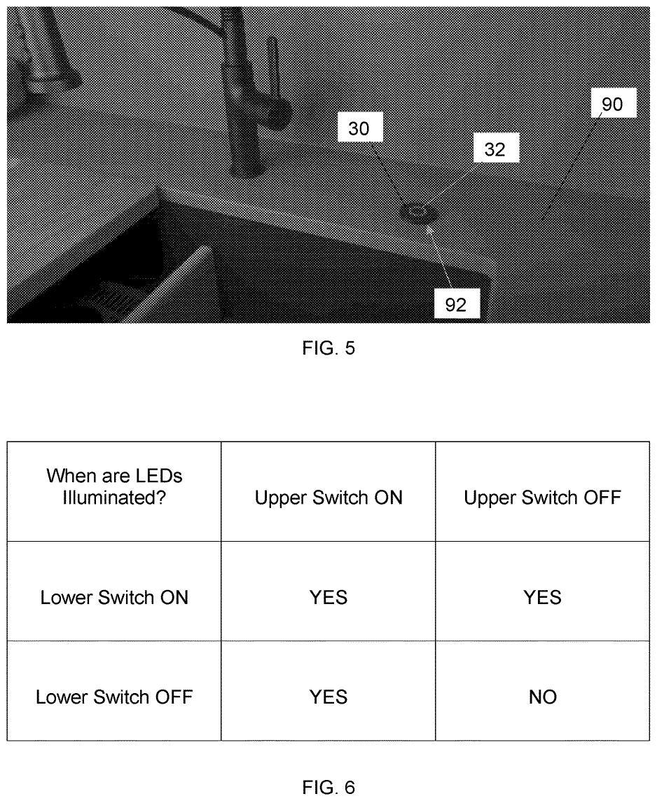

In at least one embodiment, the garbage disposal 10 and/or the light fixture 20 may be controlled by a first switch 30, as shown in FIG. 5. In the embodiment of FIG. 5, the first switch 30 is positioned on a kitchen countertop 90. This first switch 30 is arranged above the garbage disposal and may therefore be referred to as an “upper switch.” The upper switch may be conveniently configured for mounting in a standard soap dispenser hole 92 on the kitchen countertop such that no additional holes need to be drilled in an existing countertop when installing the upper switch 30. In the embodiment shown in FIG. 5, the upper switch 30 is a pushbutton toggle switch. The upper switch 30 also includes a light in the form of an LED ring 32. The LED ring 32 illuminates when power is provided to the garbage disposal and it is running. The LED ring 32 advantageously illuminates to visibly indicate that the garbage disposal is on. This is particularly useful as garbage disposals become quieter and more difficult to hear during operation. Illumination of the LED ring 32 during operation of the garbage disposal 10 provides a visual clue of operation and is particularly advantageous in view of the noise encountered in a typical residential kitchen, including noises from televisions, music, family members, guests, etc., which can tend to drown out the noise of the garbage disposal.

Referring again to FIG. 1, in another embodiment, the light fixture 20 on the garbage disposal 10 is also (or alternatively) controlled by a switch 40 mounted on the housing 11 of the garbage disposal 10. The switch 40 may be, for example, a toggle switch or a touch-sensor switch, mounted on the housing 11 of the garbage disposal. This switch 40 allows a person inspecting the garbage disposal—or the cabinet in which the garbage disposal rests—to simply flip the switch to an ON state and immediately receive light within the cabinet and around the garbage disposal.

In another embodiment, the light fixture 20 on the garbage disposal 10 is controlled by a switch 40 that is associated with a sensor 50 mounted on the housing 11 of the garbage disposal 10 or in another nearby location (e.g., in the under-cabinet compartment that houses the garbage disposal). The sensor may be, for example, a motion sensor mounted on the front of the garbage disposal 10 in the vicinity of the LED ring 22. As another example, the motion sensor may simply detect motion of the cabinet door or the state of the cabinet door as open or closed. In either event (i.e., when the cabinet doors are opened and/or motion is detected), the LEDs will shine and provide light around the garbage disposal 10 and into the cabinet housing the garbage disposal.

It will be recognized that any of various sensors may be used as the sensor 50 that provides a trigger for the switch 40 that turns on the light fixture 20 and causes the LED ring 22 to shine. Examples of such sensors include passive infrared (PIR) sensors, area reflective sensors, microwave sensors, ultrasonic sensors, video motion sensors, and dual technology (hybrid) sensors, etc. In the event the sensor 50 is a motion sensor, the sensor may be configured to detect a hand (or other body part) in close proximity to the sensor 50. For example, when the motion sensor 50 detects the presence of a human hand in the space immediately in front of the sensor (e.g., within some range such as six inches of the sensor, two inches of the sensor, etc.) the sensor 50 is triggered. When the sensor 50 sends a control signal to a controller associated with the light fixture 20, electric power is provided to the light fixture, causing light to shine from the light fixture.

In various embodiments, the LED ring 22 on the garbage disposal 10 and the LED ring 32 on the countertop switch 30 may be configured to shine at the same time or independently from one another. For example, in one embodiment, the LED ring 22 under the cabinet on the garbage disposal 10 will only shine when a motion detector senses that that cabinet door is open, and the LED ring 32 on the countertop power switch 30 will only shine when the garbage disposal is in operation. In another embodiment, the LED rings 22, 32 both shine any time the garbage disposal is in operation.

### Operation of Garbage Disposal and Light Fixture

With reference to FIG. 6 a table is provided showing the state of the light fixture 20 on the garbage disposal 10 when the upper switch 30 and the lower switch 40 are in various positions. In this embodiment, the upper switch 30 always controls operation of the garbage disposal 10 (i.e., controls electric power to the motor of the disposal), and the lower switch 40 only controls the light fixture 20, subject to the position of the upper switch 30. Specifically, when the upper switch 30 is in an ON state (i.e., when the switch 30 is flipped such that power is delivered to the motor of the garbage disposal), the LED ring 22 of the light fixture 20 is always illuminated. This is noted by a “YES” in each row of the column with the heading “Upper Switch ON” in FIG. 6. However, when the upper switch 30 is in an OFF state (i.e., when the switch 30 is flipped such that no power is delivered to the garbage disposal), the LED ring 22 is illuminated depending on the state of the lower switch 40. Specifically, when the upper switch is OFF and the lower switch is ON, the light fixture 20 is illuminated, as noted by the “YES” at this intersection in the table. However, when the upper switch is OFF and the lower switch is also OFF, the light fixture 20 is not illuminated, as noted by the “NO” at this intersection in the table. A controller may be used to selectively deliver electric power to the light fixture 20 dependent on the state of the upper and lower switches. The controller is typically located within the garbage disposal, such as behind the switch 40.

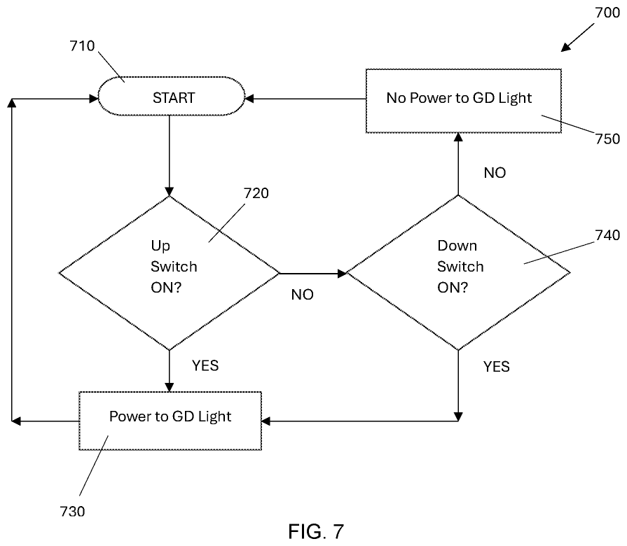

FIG. 7 shows a flowchart 700 illustrating a method used by the controller for determining when to illuminate the light fixture 20 on the garbage disposal 10. As shown in the flowchart 700, the method begins at a start block 710 and immediately moves to a decision block 720 where a determination is made whether the upper switch 30 is ON or OFF. When the upper switch 30 is ON, the method moves to block 730 and electric power is delivered to the light fixture 20 (i.e., “GD light” in block 730) and the light fixture is illuminated regardless of the position of the lower switch 40. However, when the upper switch 30 is OFF, the method continues to decision block 740 and a determination is made whether the lower switch 40 is ON or OFF. If a determination is made that the lower switch is ON in decision block 740, the method continues to block 730 and the electric power is delivered to the light fixture. On the other hand, if a determination is made that the lower switch is OFF in decision block 740, the method continues to block 750 and no electric power is delivered to the light fixture. In either event, the method then returns to the start block 710 and the method is repeated by the controller. While FIGS. 6 and 7 show one embodiment for control of the light fixture, it will be recognized that other arrangements are also possible, such as the lower switch 40 always controlling whether the LEDs are illuminated.

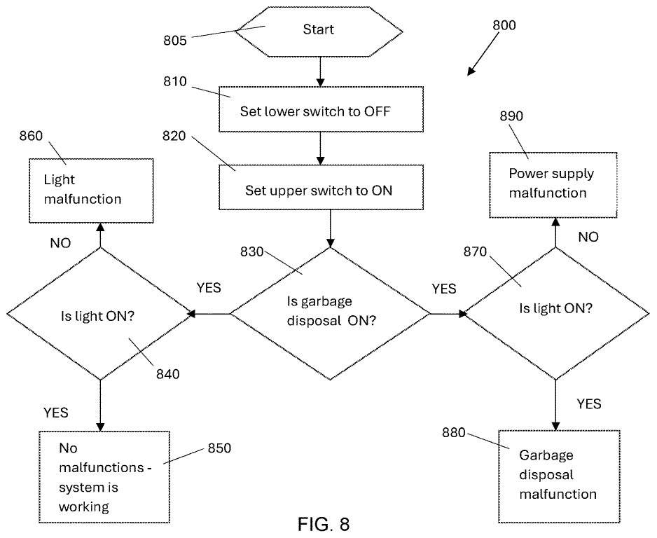

When both an upper switch 30 and a lower switch 40 are used in association with the garbage disposal, as described above, the LED rings 22 and 32 serve as a useful troubleshooting/diagnostic tool, providing clues concerning faulty operation of the garbage disposal. For example, FIG. 8 shows a flowchart 800 illustrating a method for diagnosing possible fault conditions for the garbage disposal based on illumination of the lower LED ring 32. The exemplary method is one of several possible methods that may be implemented to diagnose fault conditions with respect to the garbage disposal 10, its components, and the related switches 30, 40 and sensor(s) 50. In the exemplary method 800 of FIG. 8, the method begins at block 805 and the technician/user is instructed to first set the lower switch 40 to the OFF position at block 810. Thereafter, at block 820, the technician is instructed to set the upper switch 30 to the ON position.

After the upper switch 30 is moved to the ON position, a determination is made at block 830 whether the motor for the garbage disposal 10 is activated and spins the grinder. If it is determined that the garbage disposal is on at block 830, the technician then looks to see whether the light fixture 20 on the garbage disposal 10 is illuminated at block 840. If the light fixture 20 is illuminated (i.e., the illumination state of the light fixture 20 is “ON”), the technician may determine at block 850 that there are no malfunctions in the electrical connections and the garbage disposal is working. However, if the light fixture is not illuminated at block 840 (i.e., the illumination state of the light fixture 20 is “OFF”), the technician may determine that the light is malfunctioning at block 860. Such malfunctioning may be a result of faulty wiring or a burned out light bulb/LED on the light fixture 20.

Returning to decision block 830, if the garbage disposal does not turn on after the technician sets the upper switch 30 to ON, the technician then determines at decision block 870 whether the light fixture 20 on the garbage disposal is ON. If a determination is made that the light fixture 20 is illuminated at decision block 870 (i.e., the illumination state of the light fixture 20 is “ON”), the method moves on to block 880 and a determination is made that the garbage disposal is malfunctioning. In other words, when the upper switch 30 is ON and the LED ring 22 is illuminated but the electric motor does not operate, this indicates a likely problem with the electric motor (e.g., a burned-out motor). However, if a determination is made at decision block 870 that the light fixture 20 is not illuminated (i.e., the illumination state of the light fixture 20 is “OFF”), the method moves on to block 890 and a determination is made that the power supply is malfunctioning. In other words, when the upper switch 30 is ON but neither the electric motor nor the LED ring 22 of the garbage disposal operate, this likely suggests that the unit is not receiving power (e.g., because of an issue with the power supply circuit, such as faulty wiring or a tripped circuit breaker or GFCI outlet).

The foregoing method 800 illustrated one exemplary method for providing a diagnostic tool used to diagnose issues with the garbage disposal. In other embodiments, additional indicators may be used to provide additional information concerning the garbage disposal 10, such as the LED ring 32 on the upper switch 30. The above-described diagnostic tool may be used at any time during installation of the garbage disposal in a kitchen, including a diagnostic tool to determine whether the garbage disposal is properly installed as well as a diagnostic tool to determine malfunctions in the garbage disposal or its wiring well after installation of the garbage disposal.

### Countertop Power Switch With Outlet Adapter

With reference now to FIG. 9, in one embodiment, the upper switch 30 that controls operation of the garbage disposal 10 is provided as a countertop switch 930 of a power control device 900. The power control device 900 is provided as part of a kitchen sink installation, including a kitchen sink 80 installed on a countertop 90 and a garbage disposal 10 installed under the kitchen sink, as described above in association with FIGS. 5 and 6. The power control device 900 is configured to control operation of the garbage disposal 10, including the electric motor of the garbage disposal and/or any light fixtures 20 associated with the disposal.

With continued reference to FIG. 9, the power control device 900 includes a countertop switch 930 and a power adapter 960. The countertop switch 930 is configured for mounting on and/or in a countertop. The countertop switch 930 includes a lower body 934 and an upper face 936. The lower body 934 includes outer walls that house electronic components of the switch 930. As noted previously herein, the switch may be any of various types of switches such as a toggle switch or a touch-sensor switch to name a few.

The outer walls of the lower body 934 are configured to pass through a hole 92 in the countertop, such as a standard soap dispenser hole. Accordingly, the lower body 934 may be easily dropped into such a hole in the countertop or removed therefrom. In at least one embodiment, the outer walls 935 of the lower body 934 are cylindrical in shape such that the cylindrical surface of the lower body closely engages the perimeter of the hole in the countertop and prevents excessive movement of the switch 930 within the hole. In other embodiments, the outer walls 935 of the lower body 934 may form a rectangular or block-like shape, but the corners of the outer walls may closely engage the perimeter of the hole in the countertop, thus preventing excessive movement of the switch 930 upon the countertop.

The upper face 936 of the switch 930 includes an outer rim 938 that is not configured to pass through the hole 92. More specifically, the diameter of the outer rim 938 is greater than the diameter of the hole 92 formed in the countertop 90 such that the upper face 936 rests on the countertop without passing through the hole 92. As noted previously, the hole 92 may be a soap dispenser hole in the countertop. Accordingly, the diameter of the hole 92 is generally between 0.5 inches and 1.5 inches, and the diameter of the outer rim 938 of the upper face 936 is generally about 0.5 to 1.0 inches greater than the diameter of the hole.

In at least some embodiments wherein the switch 930 is a pushbutton switch, the center 937 of the upper face 936 is moveable relative to the outer rim 938 such that the center 937 may be depressed downwardly to move the switch to an “on” state/position, and then in succession released upwardly in order to move the switch 930 to “off” state/position. Repeated depression of the center 937 of the upper face 936 causes the switch to toggle between the “on” state (wherein the switch relays electrical power) and the “off” position (wherein the switch blocks/does not relay electrical power). In other embodiments, the switch 930 may be differently configured, such as a touch-sensor switch that allows the user to repeatedly touch the center 937 of the upper face 936 in order to toggle the switch 930 between the “on” and “off” states.

Similar to the embodiment described above, the upper face 936 of the switch 930 also includes a light 932, such as an LED ring. The light 932 is illuminated when the switch 930 is in the “on” state, and is unilluminated when the switch 930 is in the “off” state. This light 932 provides the user with a convenient indicia of garbage disposal operation that is immediately in front of the user on the countertop. In at least some embodiments, the lights of the LED ring may include different colors to indicate the status of the switch and the associated garbage disposal. For example, the LED ring 932 may illuminate with blue lights when the switch 930 is in the “off” state and the garbage disposal is deprived of power, and the LED ring 932 may illuminate with red lights when the switch 930 is in the “on” state and the garbage disposal is running.

With continued reference to FIG. 9, the power control device 900 further includes a power adapter 960 electrically connected to the switch 930. The power adapter 960 includes a housing 962 with prongs 964 on one side of the housing and at least one receptacle 966 on an opposite side of the housing 962. The prongs 964 of the power adapter 960 are configured to engage an electrical power outlet, such as a standard grounded electrical power outlet (i.e., 3-prong receptacle). The receptacles 966 of the power adapter 960 are configured to receive a 2-prong or 3-prong power plug, and particularly the power plug of the garbage disposal 10. The power adapter 960 further includes a side receptacle 968. This side receptacle 968 is configured to receive an electrical lead 970 from the switch 930.

As shown in FIG. 9, the electrical lead 970 extends between the switch 930 and the power adapter 960. The electrical lead 970 includes a proximal end 972 and a distal end 974. The proximal end 972 is fixedly connected (i.e., hardwired) to the switch 930. The distal end 974 is configured to be releasably connected to the power adapter 960. To this end, the distal end 974 includes a plug 978 that is configured to fit into the side receptacle 968 on the power adapter 960. When the plug 978 is seated in the receptacle 968, an electrical connection is established between the switch 930 and the power adapter 960. This allows electrical signals to be sent from the switch 930 to the power adapter 960, and more specifically, electrical signals indicating an “on” state or and “off” state of the switch. The distal end 974 of the lead 970 may also be removed from the power adapter by unseating the plug 978 from the receptacle 968.

In at least one embodiment, the power control device 900 is included as part of a kit for use in a kitchen sink installation with a garbage disposal. The dotted line 980 in FIG. 9 represents packaging for the kit. The packaging may be any conventional packaging such as cardboard and/or plastic containers (e.g., bags, boxes, etc.) configured to retain different parts of the power control device 900 in one convenient package. In at least one embodiment, the kit includes a garbage disposal 10 in addition to the power control device 900, wherein the garbage disposal 10 and the power control device 900 are both contained within a unitary package structure.

In operation, the power control device 900 is configured for use with a garbage disposal in a kitchen sink installation. Accordingly, a method is disclosed for providing power to a garbage disposal positioned below a kitchen sink and an associated countertop. The method first includes preparing the countertop to receive the switch 930 of the power control device 900. This may include either drilling a hole in the countertop or removing a soap dispenser from an existing hole in the countertop. As discussed previously herein, the size of the hole is sufficient to pass the lower body 934 of the switch without allowing the upper face 936 of the switch to pass therethrough.

Once the countertop is prepared with an appropriately sized hole, the method continues by mounting the switch 930 in the hole in the countertop. The switch 930 is easily and conveniently mounted in the countertop by fishing the electrical lead 970 connected to the switch through the hole, inserting the lower body 934 of the switch 930 into the hole, and then resting the upper face 936 on the countertop with the outer rim 938 surrounding the hole in the countertop and engaging an upper surface of the countertop.

After the switch 930 is mounted on the countertop, the method continues by providing an electrical connection between the switch 930 and the power adapter 960. This is accomplished by plugging the plug 978 on the distal end of the lead 970 into the side receptacle 968 of the power adapter 960. This establishes an electrical connection between the switch and the power adapter.

After an electrical connection is established between the switch 930 and the power adapter 960, the power adapter 960 is plugged into a standard 3-prong outlet located under the countertop. This provides electrical power to the power adapter 960, wherein the electrical power available at the receptacle 966 of the power adapter is controlled by the switch 930 (i.e., the switch being in either the “on” state to make power available at the receptacle 966 or the “off” state to deprive the receptacle 966 of power).

With electrical power selectively available at the power adapter 960, the method then continues by plugging a power plug connected to the garbage disposal 10 into the at least one receptacle 966 of the power adapter. Thereafter, the user selectively operates the countertop switch 930 to cause the power adapter 960 to provide electrical power to the garbage disposal 10 or deprive the garbage disposal of electrical power (i.e., by moving the switch to the “on” state to operate the electric motor of the garbage disposal or moving the switch to the “off” state to turn off the electric motor of the garbage disposal). In at least some embodiments, the user selectively operating the switch includes the user pressing the pushbutton 937 on the face 936 of the switch 930 inwardly/downwardly a first time to cause the power adapter 960 to provide electrical power to the garbage disposal 10 and pressing the pushbutton 937 on the switch 930 inwardly/downwardly a second time to cause the power adapter 960 to deprive the garbage disposal 10 of electrical power. In at least some embodiments, the method further includes illuminating at least one LED 932 on the face 936 of the switch 930 when the pushbutton 937 is pressed inwardly the first time (i.e., to the “on” state) and unilluminating the LED when the pushbutton 937 is pressed inwardly the second time (i.e., to the “off” state).

Although various embodiments of a garbage disposal with a light fixture have been provided herein, it will be appreciated by those of skill in the art that other implementations and adaptations are possible. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by any eventually appended claims.

1. A power control device for a garbage disposal positioned below a kitchen sink mounted in a countertop, the power control device comprising:
a switch configured for mounting on the countertop;
an electrical lead including a proximal end and a distal end, the proximal end connected to the switch; and
a power adapter connected to the switch via the electrical lead with the distal end of the electrical lead connected to the power adapter, the power adapter including prongs and at least one receptacle, wherein the prongs are configured for insertion into a power outlet and the at least one receptacle is configured to receive a power plug of the garbage disposal.

2. The power control device of claim 1 wherein the switch is moveable between an on position and an off position.

3. The power control device of claim 1 wherein the power adapter is configured to relay power to the garbage disposal when the switch is in an on state, the prongs of the power adapter are plugged into the power outlet, and the power plug of the garbage disposal is plugged into the receptacle of the power adapter.

4. The power control device of claim 3 wherein the power adapter is further configured to block power to the garbage disposal when the switch is in an off state.

5. The power control device of claim 4 wherein the switch is a pushbutton switch.

6. The power control device of claim 5, the pushbutton switch including a light, wherein the light is illuminated when the pushbutton switch is on and the light is not illuminated when the pushbutton switch is off.

7. The power control device of claim 6 wherein the light is an LED ring arranged on a face of the pushbutton switch.

8. The power control device of claim 1 wherein the distal end of the electrical lead is releasably connected to the power adapter.

9. The power control device of claim 1 wherein the at least one receptacle of the power adapter includes two receptacles.

10. The power control device of claim 1 wherein the switch includes a lower body and an upper face, the lower body configured to pass through a hole in the countertop, the upper face including an outer rim that is not configured to pass through the hole.

11. The power control device of claim 10 wherein the hole is a soap dispenser hole in the countertop.

12. The power control device of claim 1 wherein the switch, the power adapter, and the electrical lead are arranged in packaging as a garbage disposal control kit.

13. The power control device of claim 12 wherein the garbage disposal is included within the packaging.

14. A method of providing power to a garbage disposal positioned below a kitchen sink and an associated countertop, the method comprising:
mounting a switch in a hole in the countertop;
providing an electrical connection between the switch and a power adapter;
plugging the power adapter into an outlet under the countertop, the power adapter including at least one receptacle;
plugging a power plug connected to the garbage disposal into the at least one receptacle; and
selectively operating the switch to cause the power adapter to provide electrical power to the garbage disposal or deprive the garbage disposal of electrical power.

15. The method of claim 14 wherein mounting the switch in the hole of the countertop includes inserting a lower body into the hole in the countertop and resting an upper rim of the switch on a top surface of the countertop.

16. The method of claim 14 wherein providing an electrical connection between the switch and the power adapter includes plugging a distal end of a lead of the switch into the power adapter.

17. The method of claim 14 wherein selectively operating the switch includes pressing a pushbutton on the switch inwardly a first time to cause the power adapter to provide electrical power to the garbage disposal and pressing the pushbutton on the switch inwardly a second time to cause the power adapter to deprive the garbage disposal of electrical power.

18. The method of claim 17 further comprising illuminating at least one LED on a face of the switch when the pushbutton is pressed inwardly the first time and unilluminating the at least one LED when the pushbutton is pressed inwardly the second time.

19. The method of claim 14 further comprising, prior to mounting the switch in the hole in the countertop, removing a soap dispenser from the hole.

20. A kitchen sink installation comprising:
a countertop;
a kitchen sink installed in the countertop;
a garbage disposal installed under the kitchen sink, the garbage disposal including a power cord and a power plug; and
a power control device for the garbage disposal, the power control device comprising:
a switch mounted on the countertop, and
a power adapter electrically connected to the switch, the power adapter including prongs and at least one receptacle, the prongs engaging an electrical power outlet and the power plug of the garbage disposal plugged into the at least one receptacle.
